(19) United States
(12) Patent Application Publication
(10) Pub. No.: US 2014/0334285 A1
(43) Pub. Date: Nov. 13, 2014

(54) BASE STATION APPARATUS FOR DECREASING AMOUNT OF TRANSMISSION DATA WITH CLOUD RADIO ACCESS NETWORK

(71) Applicant: INNOWIRELESS CO., LTD., Seongnam-si (KR)

(72) Inventors: Jin-Soup JOUNG, Gyeonggi-do (KR); Joo-Hyeong LEE, Seoul (KR); Yong-Hoon LIM, Seoul (KR); Hee-Jun LEE, Seoul (KR); Chul-Woo YOO, Seoul (KR)

(73) Assignee: INNOWIRELESS CO., LTD., Seongnam-si (KR)

(21) Appl. No.: 13/903,333

(22) Filed: May 28, 2013

(30) Foreign Application Priority Data
May 9, 2013 (KR) 10-2013-0052643

(51) Int. Cl. H04W 28/06

(52) U.S. Cl. CPC H04W 28/06
USPC 370/210

(57) ABSTRACT

There is disclosed a base station apparatus having a cloud radio access network (CRAN) structure. The base station apparatus includes a digital unit (DU) that includes a baseband processing unit for processing signals of a baseband, a Fast Fourier Transform (FFT) operation unit that converts baseband signals of a time domain into signals of a frequency domain, an Inverse FFT (IFFT) operation unit that converts signals of a frequency domain into signals of a time domain, and a radio unit (RU) that processes radio signals with respect to a terminal, and transmits and receives the processed signals, wherein the FFT operation unit and the IFFT operation unit are provided in the RU to reduce an amount of transmission and reception data between the DU and the RU.

### CROSS-REFERENCE TO RELATED APPLICATION

This application claims priority to and the benefit of Korean Patent Application No. KR 10-2013-0052643, filed on May 9, 2013, the disclosure of which is incorporated herein by reference in its entirety.

### BACKGROUND

1. Field of the Invention

The present invention relates to a base station apparatus having a cloud radio access network (CRAN) structure, and more particularly, to a base station apparatus having a CRAN structure, which may reduce an amount of data transmitted from a digital unit (DU) to a radio unit (RU) by re-distributing a function of the RU so that a Fast Fourier Transform (FFT) operation and an Inverse Fast Fourier Transform (IFFT) operation can be performed in the RU itself in a base station apparatus having a CRAN structure in which the DU and the RU are separated.

2. Discussion of Related Art

FIG. 1 is a block diagram of a base station apparatus in an Orthogonal Frequency Division Multiplexing (OFDM) system having a general cloud radio access network (CRAN) structure. As shown in FIG. 1, in a recent base station system, the CRAN structure implemented by separating a digital signal processing unit (DU; Digital unit) 10 and a radio signal processing unit (RU; Radio Unit) 20 of the base station system has been widely introduced in order to reduce capital expenditure (CAPEX) and operational expenditure (OPEX) and ensure the efficiency of equipment development. Such a CRAN is one kind of Cloud Communication Center (CCC), and may reduce OPEX and power consumption in addition to significantly increasing a wireless data capacity compared to an existing system.

As described above, the DU 10 is conventionally concentrated in a DU center provided separately in a station, whereas the RU 20 is provided in a service target area far away from the DU 10. Accordingly, high speed transmission and reception of baseband I/Q signals between the DU 10 and the RU 20 is required, and therefore the DU 10 and the RU 20 are physically connected to an optical link or an Unshielded Twisted Pair (UTP) 30. In this instance, a plurality of frequency assignments (FA) and sector signals may be mixed between the DU 10 and the RU 20, and therefore the number of optical cables for connecting these signals may be determined in accordance with an I/Q data transfer amount.

In this manner, since the DU 10 and the RU 20 are physically far apart from each other, facility costs of the optical cable are significantly increased, and therefore it is possible to reduce CAPEX by reducing the amount of data between the DU 10 and the RU 20.

A standard that is most commonly used in transmission and reception of I/Q data between the DU 10 and the RU 20 is a Common Public Radio Interface (CPRI), and a line data rate as a standard of the latest version (Ver 5.0) may support up to 9.8304 Gbps.

Meanwhile, specifically, the DU 10 includes a baseband processing unit 12 and a Fast Fourier Transform (FFT) and Inverse FFT (IFFT) operation unit (hereinafter, referred to as “FFT/IFFT operation unit”) 14, and may further include an automatic gain control (AGC) circuit unit 16, if necessary. The RU 20 includes a D/A conversion unit 23, an A/D conversion unit 24, a transceiver 26, a front end circuit unit 28, and a transmission and reception antenna (ANT).

In the above-described configuration, in case of an OFDM system such as a Long Term Evolution (LTE), WiMAX, or the like, a larger FFT/IFFT size is implemented compared to a subcarrier of data to be transmitted, and therefore there are a lot of redundancies on frequencies. Accordingly, digital I/Q data generated before an actual IFFT operation of the DU 10 is significantly smaller than digital I/Q data transmitted through CPRI after the IFFT operation. In addition, since the I/Q data generated after the IFFT operation is a multicarrier signal, the I/Q data has a significantly large dynamic range. On the other hand, since the data generated before the IFFT operation is a single carrier signal, implementation may be possible even with a much less bit resolution.

However, according to a base station apparatus having a CRAN structure of the related art, since the FFT and IFFT operation units are all provided in the DU, a relatively larger amount of data that has been subjected to FFT and IFFT is transmitted to the RU through the optical cable, and therefore networking costs for data transmission between the DU and RU and operating costs may be increased.

### SUMMARY OF THE INVENTION

The present invention is directed to a base station apparatus having a cloud radio access network (CRAN) structure, which may reduce an amount of data transmitted from a digital unit (DU) to a radio unit (RU) by re-distributing a function of the RU so that a Fast Fourier Transform (FFT) operation and an Inverse Fast Fourier Transform (IFFT) operation can be performed in the RU itself in a base station apparatus having a CRAN structure in which the DU and the RU are separated, and therefore it is possible to reduce networking costs for data transmission between the DU and RU and to reasonably transmit a plurality of sector or multicarrier signals.

According to an aspect of the present invention, there is provided a base station apparatus having a cloud radio access network (CRAN) structure, the base station apparatus including: a digital unit (DU) that includes a baseband processing unit for processing signals of a baseband; a Fast Fourier Transform (FFT) operation unit that converts baseband signals of a time domain into signals of a frequency domain; an Inverse FFT (IFFT) operation unit that converts signals of a frequency domain into signals of a time domain; and a radio unit (RU) that processes radio signals with respect to a terminal, and transmits and receives the processed signals, wherein the FFT operation unit and the IFFT operation unit are provided in the RU to reduce an amount of transmission and reception data between the DU and the RU.

The base station apparatus may be applied to a Long Term Evolution (LTE) or WiMAX which uses an Orthogonal Frequency Division Multiplexing (OFDM) modulation and demodulation method, and the DU and RU may transmit and receive data with a Common Public Radio Interface (CPRI) standard.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 shows a block diagram showing a base station apparatus in an Orthogonal Frequency Division Multiplexing (OFDM) system having a cloud radio access network (CRAN) structure according to the related art; and

FIG. 2 is a block diagram showing a base station apparatus in an OFDM system having a CRAN structure according to an embodiment of the present invention.

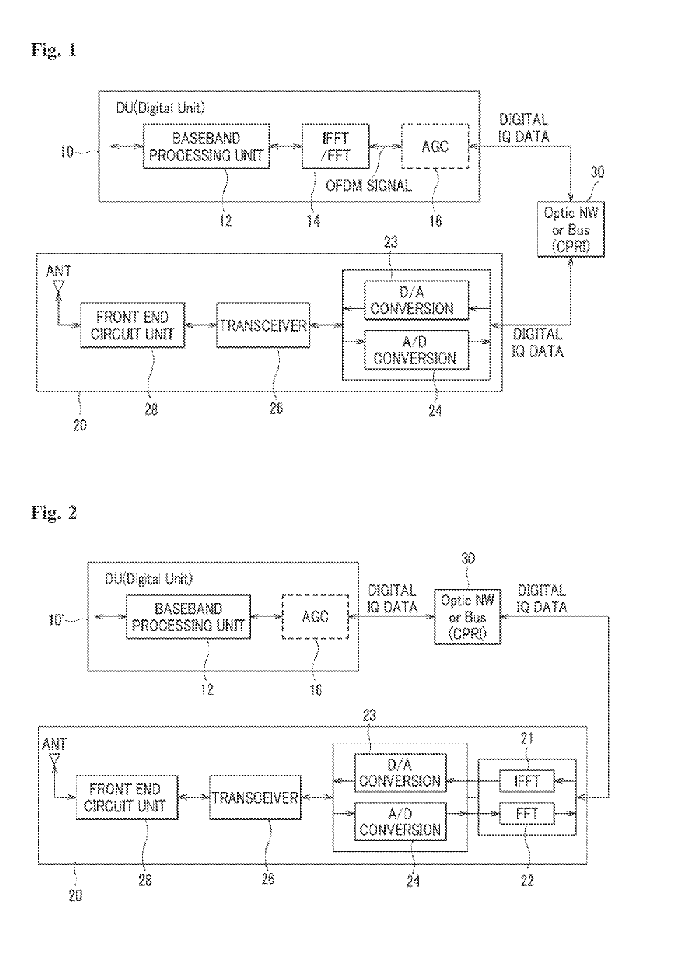

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

FIG. 2 is a block diagram showing a base station apparatus in an Orthogonal Frequency Division Multiplexing (OFDM) system having a cloud radio access network (CRAN) structure according to an embodiment of the present invention.

As shown in FIG. 2, the base station apparatus having the CRAN structure is connected through a mutual optical cable or an Unshielded Twisted Pair (UTP) 30, and includes a digital unit (DU) 10′ and a radio unit (RU) 20′ for transmitting and receiving data with a Common Public Radio Interface (CPRI) standard.

In the above-described configuration, the DU 10′ includes a baseband processing unit 12, and the RU 20′ includes a D/A conversion unit 23, an A/D conversion unit 24, a Fast Fourier Transform (FFT) operation unit 22, an Inverse FFT (IFFT) operation unit 21, a transceiver 26, a front end circuit unit 28, and a transmission and reception antenna (ANT). The DU may further include an automatic gain control (AGC) circuit unit, if necessary.

The baseband processing unit 12 performs a transmission process, a Medium Access Control (MAC) retransmission control process, and the like in a Radio Link Control (RLC) layer such as a division process of packet data, a coupling process thereof, a transmission process of RLC retransmission control, and the like, and for this, the baseband processing unit 12 includes a physical layer processing unit, an MAC processing unit, an RLC processing unit, a subcarrier mapping determining unit, a downlink transmission power control unit, and the like.

Among these, the physical layer processing unit performs a channel coding for enhancing error resistance of downlink I/Q data signals, data modulation using a modulation method such as Quadrature Phase Shift Keying (QPSK), 16-Quadrature Amplitude Modulation (QAM), or 64-QAM, interleaving, conversion (S/P conversion) of interleaved serial signals into parallel signals, multiplexing of S/P converted signals and reference signals, and the like.

The physical layer processing unit also performs a separation (DeMUX) of uplink I/Q data and reference signals, channel estimation based on reference signals, demodulation of I/Q data signals based on a channel estimation result, and the like. An AGC circuit unit 16 may be further included in the DU 10′. Meanwhile, with respect to a downlink to a user terminal, the IFFT operation 22 of the RU 20′ may receive signals that have been multiplexed by the baseband processing unit 12 and perform a modulation of an OFDM scheme by performing a high-speed IFFT operation. A symbol that has been OFDM-modulated in this manner may be converted into analog signals by the D/A conversion unit 23 later while a Cyclic Prefix (CP) is added to the symbol. Next, the transceiver 26 performs a frequency conversion to a radio frequency band with respect to output signals of the D/A conversion unit 23, and the front end circuit unit 28 amplifies output signals of the transceiver 26, and then emits the amplified signals as radio signals through the transmission and reception antenna (ANT).

With respect to an uplink from the user terminal, in the RU 20′, radio signals received through the transmission and reception antenna (ANT) are amplified by the front end circuit unit 28, and then the amplified signals are converted into baseband signals by performing a frequency downlink conversion process by the transceiver 26.

Next, the A/D conversion unit 24 of the RU 20′ converts the analog type of baseband signals output through the transceiver 26 into digital signals. The baseband signals that have been converted into the digital signals by the A/D conversion unit 24 are converted into frequency signals by the FFT operation unit 22 later while a CP is removed from the baseband signals, and therefore the frequency signals are transmitted to the DU 10′ while being demodulated in an OFDM scheme.

In the base station apparatus having the CRAN structure according to an embodiment of the present invention, only data corresponding to the number of subcarriers to which data is to be actually transmitted may be transmitted to the DU 10′ without transmitting all data corresponding to the entire FFT size, thereby reducing an amount of data transmission between the DU 10′ and the RU 20′.

In the following Table 1, an IFFT size and an actual subcarrier are compared with respect to each bandwidth of an LTE system, and an effect of removing redundancy existing on a frequency of the OFDM signal is shown.

TABLE 1

| Channel bandwidth [MHz] | 1.4 | 3 | 5 | 10 | 15 | 20 |
|---|---|---|---|---|---|---|
| Data occupation subcarriers | 72 | 180 | 300 | 600 | 900 | 1200 |
| Number of FFTs | 128 | 256 | 512 | 1024 | 1024 | 2048 |
| \textcircled{1} Frequency redundancy reduction rate [%] | 43.8% | 29.7% | 41.4% | 41.4% | 12.1% | 41.4% |
| \textcircled{2} Bit resolution reduction rate [%] | 46.7% | | | | | |
| (Assuming 8-bit implementation) | | | | | | |
| Total reduction rate (\textcircled{1}&\textcircled{2}) | 70.0% | 62.5% | 68.8% | 68.8% | 53.1% | 68.8% |

Meanwhile, I/Q data generated after the IFFT operation may be approximated to a Gaussian noise as multicarrier signals, and the approximated signals may be signals having a large Peak-to-Average Power Ratio (PAPR). Accordingly, corresponding signals have a significantly large dynamic range, and therefore each of the I/Q data may be generally implemented with about 15 bits. Therefore, even in a CPRI standard, each of I/Q sample data is specified so that each of I/Q sample data can be set with up to 15 bits.

However, since the signals before the IFFT operation are single carrier signals having several fixed values, that is, QPSK, 16-QAM, or 64-QAM, each of the I/Q sample data may be represented with a much lower bit resolution, for example, about 7 and 8 bits.

According to an embodiment of the present invention, like the related art, instead of transmitting multi-carrier signals with a large dynamic range which are generated after performing the IFFT operation, single carrier signals before performing the IFFT operation may be transmitted to the RU, thereby implementing each sample even with a much lower bit resolution.

As shown in the above Table 1, when assuming that a bit resolution of each sample is implemented as 8, a reduction amount of transmission data that can be applied to each LTE band is about 46.7%. For example, in case of an LTE 10 MHz band, a total reduction amount of transmission data may be increased up to about 69, but this is a gain obtained by a simple change in an installation position, and therefore data loss may not occur.

As described above, in the base station apparatus having the CRAN structure according to an embodiment of the present invention, the FFT operation and the IFFT operation are all performed in the RU, and therefore single carrier signals are transmitted and received between the DU and the RU. As a result, an amount of data to be transmitted may be significantly reduced, and therefore networking costs between the DU and the RU and operating costs may be reduced, and a plurality of sector or multicarrier signals may be reasonably transmitted.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A base station apparatus having a cloud radio access network (CRAN) structure, comprising:
a digital unit (DU) that includes a baseband processing unit for processing signals of a baseband;
a Fast Fourier Transform (FFT) operation unit that converts baseband signals of a time domain into signals of a frequency domain;
an Inverse FFT (IFFT) operation unit that converts signals of a frequency domain into signals of a time domain; and
a radio unit (RU) that processes radio signals with respect to a terminal, and transmits and receives the processed signals,
wherein the FFT operation unit and the IFFT operation unit are provided in the RU to reduce an amount of transmission and reception data between the DU and the RU.

2. The base station apparatus of claim 1, wherein the base station apparatus is applied to a Long Term Evolution (LTE) or WiMAX which uses an Orthogonal Frequency Division Multiplexing (OFDM) modulation and demodulation method, and
the DU and RU transmit and receive data with a Common Public Radio Interface (CPRI) standard.
